(19) United States
(12) Patent Application Publication
(10) Pub. No.: US 2022/0353362 A1
(43) Pub. Date: Nov. 3, 2022

(54) ELECTRONIC DEVICE AND CONTROL METHOD THEREFOR

(71) Applicant: SAMSUNG ELECTRONICS CO., LTD., Suwon-si (KR)

(72) Inventors: Kyoungshin JIN, Suwon-si (KR); Dongwook KIM, Suwon-si (KR); Minsup KIM, Suwon-si (KR); Jaeyong KIM, Suwon-si (KR); Hyuna SONG, Suwon-si (KR); Sungho CHAE, Suwon-si (KR)

(73) Assignee: SAMSUNG ELECTRONICS CO., LTD., Suwon-si (KR)

(21) Appl. No.: 17/857,536

(22) Filed: Jul. 5, 2022

Related U.S. Application Data
(63) Continuation of application No. PCT/KR2021/000009, filed on Jan. 4, 2021.
(60) Provisional application No. 62/957,390, filed on Jan. 6, 2020.

(30) Foreign Application Priority Data
Apr. 17, 2020 (KR) 10-2020-0046484

(51) Int. Cl. H04M 1/72454

(52) U.S. Cl. CPC H04M 1/72454; H04M 2250/12

(57) ABSTRACT

An electronic device according to an embodiment of the present invention comprises: an interface; a sensor; and a processor that identifies whether a user event corresponding to a content transmission command has occurred, on the basis of a signal detected via the sensor, and performs a content transmission operation between external apparatuses via the interface on the basis of the identified user event. The processor may identify whether the occurrence of the user event is expected, on the basis of acquired surrounding situation information, when the occurrence of the user event is identified as being expected, increase the recognition sensitivity of the sensor, and identify the user event on the basis of a signal detected via the sensor having the increased recognition sensitivity.

### CROSS-REFERENCE TO RELATED APPLICATIONS

This application is a continuation application, under 35 U.S.C. § 111(a), of International Patent Application No. PCT/KR2021/000009, filed on Jan. 4, 2021, which claims the benefit of U.S. Patent Application No. 62/957,390 filed on Jan. 6, 2020, in the U.S. Patent and Trademark Office and Korean Patent Application No. 10-2020-0046484, filed on Apr. 17, 2020, in the Korean Intellectual Property Office, the entire disclosures of each of which are incorporated herein by reference as a part of this application.

### BACKGROUND

### Field

The disclosure relates to an electronic device and a control method thereof which connect with another electronic device and transmit/receive a content.

### Description of Related Art

Recently, as various functions such as content transmission/reception by connecting with electronic devices increase, technologies to easily and conveniently connect the electronic devices have been developed.

As the technologies to connect the electronic devices, a simple and intuitive method such as making both electronic devices be in contact physically may be embodied. In this case, a sensor has an important role, where if the sensor always operates, power is unnecessarily consumed, and if a threshold by which the sensor recognizes is fixed, there exists a limit to a recognition rate.

### SUMMARY

An electronic device according to an embodiment of the disclosure may include: an interface; a sensor; and a processor configured to: identify whether a user event which corresponds to a content transmission command occurs based on a signal that is detected through the sensor; and perform a content transmission operation with an external device through the interface based on the identified user event, wherein the processor is further configured to: identify whether the user event is expected to occur based on acquired surrounding situation information; when the user event is identified as being expected to occur, increase a recognition sensitivity of the sensor, and identify the user event based on a signal that is detected through the sensor of which the recognition sensitivity has been increased.

The sensor, while set to have a first recognition sensitivity, may detect a signal that is more than a first threshold value, whereas the sensor, while set to have a second recognition sensitivity larger than the first recognition sensitivity, may detect a signal that is more than a second threshold value lower than the first threshold value.

The sensor may detect a vibration characteristic of the signal and the processor may identify the user event based on the detected vibration characteristic.

The processor may identify that the user event is expected to occur by identifying based on the surrounding situation information that at least one of a user or the external device exists in surroundings of the electronic device.

The processor may acquire the surrounding situation information which indicates that the at least one of the user or the external device exists within a predefined distance from the electronic device.

The sensor may operate in a first operation mode and, provided the processor identifies that the user event is expected to occur, the processor may control the sensor to operate in a second operation mode in which power consumption is larger than that of the first operation mode.

Provided the processor identifies that the user event is unexpected to occur until a predefined time has passed while the sensor operates in the second operation mode, the processor may control the sensor to operate in the first operation mode.

The processor may identify whether the user event which corresponds to at least one of a predefined user or external device is expected to occur and, when the user event is expected to occur, adjust the sensor to have a third recognition sensitivity which corresponds to the at least one of the predefined user or external device.

A method of controlling an electronic device according to an embodiment of the disclosure may include: identifying whether a user event which corresponds to a content transmission command occurs based on a signal that is detected through a sensor; and performing a content transmission operation with an external device through an interface based on the identified user event, wherein the identifying whether the user event is expected to occur comprises: identifying whether the user event is expected to occur based on acquired surrounding situation information; when the user event is identified as being expected to occur, increasing a recognition sensitivity of the sensor; and identifying the user event based on a signal that is detected through the sensor of which the recognition sensitivity has been increased.

The sensor may detect a vibration characteristic of the signal and the identifying the user event may include identifying the user event based on the detected vibration characteristic.

The identifying whether the user event is expected to occur may identifying that the user event is expected to occur by identifying based on the surrounding situation information that at least one of a user or the external device exists in surroundings of the electronic device.

The method of controlling the electronic device according to an embodiment of the disclosure may further include acquiring the surrounding situation information which indicates that the at least one of the user or the external device exists within a predefined distance from the electronic device.

The sensor operates in a first operation mode and the adjusting the sensor may include, provided that the user event is identified as being expected to occur, controlling the sensor to operate in a second operation mode in which power consumption is larger than that of the first operation mode.

The controlling the sensor may include, provided the user event is identified as being unexpected to occur until a predefined time has passed while the sensor operates in the second operation mode, controlling the sensor to operate in the first operation mode.

The method of controlling the electronic device according to an embodiment of the disclosure may further include identifying whether the user event which corresponds to at least one of a predefined user or external device is expected to occur and, when the user event is expected to occur, adjusting the sensor to have a third recognition sensitivity which corresponds to the at least one of the predefined user or external device.

A recording medium storing a computer program which includes a computer-readable code to perform a method of controlling an electronic device, wherein the method may include: identifying whether a user event which corresponds to a content transmission command occurs based on a signal that is detected through a sensor; and performing a content transmission operation with an external device through an interface based on the identified user event, wherein the identifying whether the user event is expected to occur includes: identifying whether the user event is expected to occur based on acquired surrounding situation information; when the user event is identified as being expected to occur, increasing a recognition sensitivity of the sensor; and identifying the user event based on a signal that is detected through the sensor of which the recognition sensitivity has been increased.

### BRIEF DESCRIPTION OF THE DRAWINGS

FIG. 1 illustrates that an electronic device according to an embodiment of the disclosure operates.

FIG. 2 is a block diagram illustrating a configuration of an electronic device according to an embodiment of the disclosure.

FIG. 3 is a flow chart illustrating an operation of the electronic device according to an embodiment of the disclosure.

FIG. 4 illustrates a graph of a threshold value change of the sensor according to an embodiment of the disclosure.

FIG. 5 illustrates that the electronic device according to an embodiment of the disclosure operates.

FIG. 6 illustrates that the electronic device according to an embodiment of the disclosure operates.

FIG. 7 is a flow chart illustrating that the electronic device according to an embodiment of the disclosure operates.

FIG. 8 illustrates a graph of power consumption change of the sensor according to an embodiment of the disclosure.

FIG. 9 illustrates a graph of threshold value change of the sensor according to an embodiment of the disclosure.

### DETAILED DESCRIPTION

Embodiments of the disclosure will be described in detail with reference to the accompanying drawings. In the drawings, the same reference numbers or signs refer to components that perform substantially the same function, and the size of each component in the drawings may be exaggerated for clarity. The technical idea and the core configuration and operation are not limited only to the configuration or operation described in the following examples. In the disclosure, if it is determined that a detailed description of the known technology or configuration related to the disclosure may unnecessarily obscure the subject matter of the disclosure, the detailed description thereof will be omitted.

In the following embodiments, terms ‘first’, ‘second’, etc. are used only to distinguish one element from another, and singular forms are intended to include plural forms unless otherwise mentioned contextually. In the following embodiments, it will be understood that terms ‘comprise’, ‘include’, ‘have’, etc. do not preclude the presence or addition of one or more other features, numbers, steps, operation, elements, components or combination thereof. In addition, a ‘module’ or a ‘portion’ may perform at least one function or operation, be achieved by hardware, software or combination of hardware and software, and be integrated into at least one module for at least one processor. Further, a term “at least one” among a plurality of elements in the disclosure represents not only all the elements but also each one of the elements, which excludes the other elements or all combinations of the elements.

An aspect of the disclosure is to provide an electronic device and a control method thereof which is able to more efficiently raise the recognition rate between the devices.

It is possible to enhance the recognition rate of the external device, which is to be connected, by identifying the surrounding situation of the electronic device.

It is possible to efficiently reduce power consumption by identifying the surrounding situation of the electronic device.

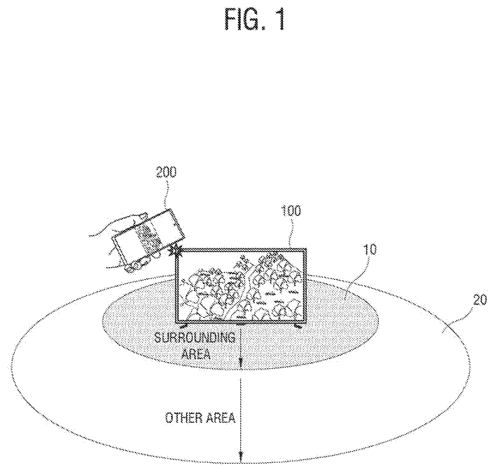

FIG. 1 illustrates that an electronic device according to an embodiment of the disclosure operates.

FIG. 1 shows an electronic device 100 and an external device 200. Here, the electronic device 100 and the external device 200 may be embodied as a display device which can display an image. For an example, the electronic device 100 and the external device 200 may include a television (TV), a computer, a smartphone, a tablet computer, a portable media player, a wearable device, a video wall, an electronic picture frame, etc.

As shown in FIG. 1, a user may make, as a user event to connect the electronic device 100 and the external device 200, a tap motion where the user brings the external device 200 into contact with the electronic device 100. Thus, the tap motion may be a simple and intuitive method which connects the two devices. However, the tap motion is merely one of various motions, which can be embodied, and may be variously applied to a gesture or touch, a voice recognition, etc. According to an embodiment, because the connection of the two devices is for transmitting/receiving a content with each other, the tap motion means a user event corresponding to a content transmission command.

The electronic device 100 may detect that the user event occurs through a sensor. The electronic device 100 according to an embodiment of the disclosure may identify whether the tap motion occurs based on a signal which is detected through the sensor that is set as a predefined recognition sensitivity. That the recognition sensitivity set in the sensor of the embodiment is high means a threshold value being low because, for example, a signal having a vibration characteristic of a weak strength may be detected. Accordingly, if the threshold value set in the sensor is low, it is possible to easily detect a signal occurring by the user event, which occurs weakly, but also to detect a signal occurring by noise, etc. not by the user event. On the other hand, if the threshold value set in the sensor is high, the signal occurring by unnecessary noise, etc. may not be detected, but the signal occurring by the user event may not be detected either. Accordingly, it is necessary for the sensor to detect the user event based on an appropriate threshold value.

As a method of appropriately setting the threshold value of the sensor, according to an embodiment of the disclosure, the threshold value may be set by identifying whether the user event of the electronic device 100 is expected to occur. Whether the user event is expected to occur may be identified according to a surrounding situation, where, for example as illustrated in the figure, there are divided a surrounding area 10 and the other area 20 of the electronic device 100. If a user or an external device 200 exists in the surrounding area 10 of the electronic device 100, the user event is expected to occur so that the threshold value may be adjusted. That is because a possibility that a situation requiring a connection between the devices occurs is high if the electronic device 100 and the external device 200 are close to each other. However, the disclosure is not limited to the embodiment and may be applied to all situations in which the user event is expected to occur.

According to an embodiment of the disclosure, it is possible to more efficiently recognize the user event by adjusting the threshold value in accordance with the surrounding situation of the electronic device.

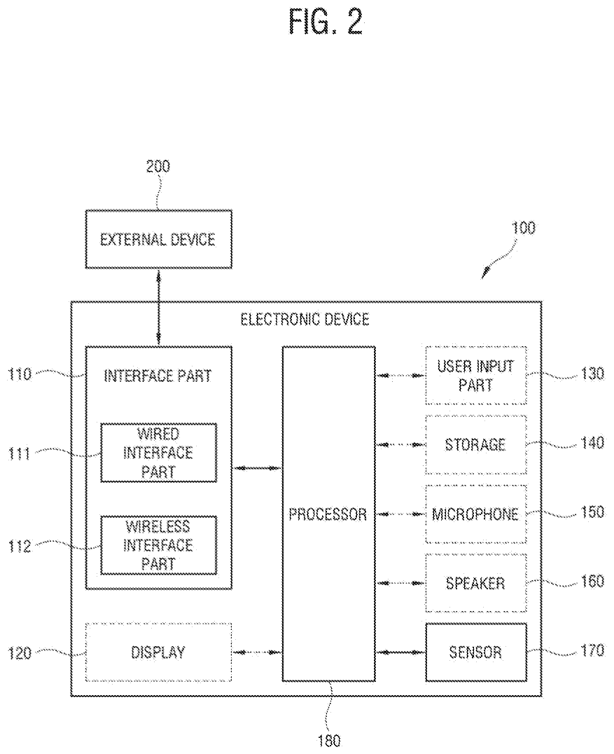

FIG. 2 is a block diagram illustrating a configuration of an electronic device according to an embodiment of the disclosure.

As shown in FIG. 2, the electronic device 100 may include an interface part 110. The interface part 110 may include a wired interface part 111. The wired interface part 111 includes a connector or port to which an antenna capable of receiving broadcast signals according to broadcasting standards, such as terrestrial broadcasting and satellite broadcasting, or/and a cable capable of receiving broadcast signals according to cable broadcasting standard may be connected. As another example, the electronic device 100 may include an antenna capable of receiving broadcast signals built therein. The wired interface part 111 may include a connector or port according to transmission standard of at least one among video or audio, such as High-Definition Multimedia Interface (HDMI), DisplayPort (DP), Digital Visual Interface (DVI), Thunderbolt, composite video, component video, super video, SCART or the like. The wired interface part 111 may include a connector or port according to universal data transmission standard, such as Universal Serial Bus (USB) or the like. The wired interface part 111 may include a connector or port to which an optical cable may be connected according to optical transmission standard. The wired interface part 111 may include a connector or port to which an external microphone or an external audio device having a microphone is connected and which is capable of receiving or inputting audio signals from an audio device. The wired interface part 111 may include a connector or port to which an audio device, such as a headset, an earphone, an external speaker and the like, is connected and which is capable of receiving or inputting audio signals to the audio device. The wired interface part 111 may include a connector or port according to network transmission standard, such as Ethernet or the like. For example, the wired interface part 111 may be implemented as Local Area Network (LAN) card or the like, which is wired to a router or a gateway.

The wired interface part 111 may be wired in a 1:1 or 1:N (here, N is a natural number) manner with an external device or an external display device, such as a set-top box, an optical media reproducing device and the like, a speaker, a server and so on via the connector or port, and may thereby transmit and receive audio/video signals therebetween. The wired interface part 111 may include a connector or port, which separately transmit the audio/video signals.

Also, according to an embodiment, the wired interface part 111 is embedded in the electronic device 100, but embodiments are not limited thereto and the wired interface part 111 may be also implemented as a dongle or module to be attached to or detached from the connector of the electronic device 100.

The interface part 110 may include a wireless interface part 112. The wireless interface part 112 may be embodied in a various manner corresponding to an embodied form of the electronic device 100. For example, the wireless interface part 112 may use, as a wireless communication method, radio frequency (RF), Zigbee, Bluetooth, Wi-Fi, ultra-wideband (UWB), near-field communication (NFC), etc. The wireless interface part 112 may be embodied as a wireless communication module for performing wireless communication with an access point (AP) according to Wi-Fi methods, a wireless communication module for performing 1:1 direct wireless communication, such as Bluetooth or the like, and so on. The wireless interface part 112 may wirelessly communicate with a server on the network, thereby transmitting and receiving data packets to and from the server. The wireless interface part 112 may include an infrared (IR) transmitter and/or an IR receiver, which can transmit and/or receive IR signals according to IR communication standard. The wireless interface part 112 may receive or a remote control signal from a remote controller or other external devices, or transmit or output the remote control signal to the remote controller or the other external devices, through the IR receiver and/or the IR transmitter. As another example, the electronic device 100 may transmit and receive the remote control signal to and from the remote controller or the other external devices through wireless interfaces part 112 of different communication standards, such as Wi-Fi, Bluetooth and so on.

In a case that video/audio signals received through the interface part 110 are broadcast signals, the electronic device 100 may further include a tuner which tune the received broadcast signals for each channel.

The electronic device 100 may include a display 120. The display 120 includes a display panel, which can display an image on a screen. The display panel is provided with a light receiving structure, such as a liquid crystal, or a spontaneous emission structure, such as an organic light emitting diode (OLED). The display 120 may include an additional construction according to the structure of the display panel. For example, in a case that the display panel is a liquid crystal type, the display 120 may include a liquid crystal display panel, a backlight configured to supply light to the liquid crystal display panel, and a panel driving substrate configured to drive the liquid crystal display panel.

The electronic device 100 may include a user input part 130. The user input part 130 includes circuitry related to various types of input interfaces, which are provided to receive a user input. The user input part 130 may be configured in many different forms according to kinds of the electronic device 100. As an example, the user input part 130 may include a mechanical or electronic button, an interface configured to receive input from a remote controller separated from the electronic device 100, a touch pad, an interface configured to receive input from an external device connected with the electronic device 100, a touch screen installed on the display 120 of the electronic device 100 and so on.

The electronic device 100 may include a storage 140. The storage 140 stores digitalized data. The storage 140 includes a non-volatile storage in which data can be stored regardless of whether or not power is provided, and a volatile memory, which loads data to be processed by a processor 180 and which loses data stored therein if power is not provided. The non-volatile storage may include a flash-memory, a hard-disc drive (HDD), a solid-state drive (SSD), a read only memory (ROM) and so on and the volatile memory may include a buffer, a random access memory (RAM) and so on.

The electronic device 100 may include a microphone 150. The microphone 150 may collect sounds of an external environment including user voices. The microphone 150 transmits signals corresponding to the collected sounds to the processor 180. The electronic device 100 may have the microphone 150 to collect the user voices, or may receive through the interface part 110 voice signals from an external device, such as a remote controller having the microphone, a smartphone and the like. The external device may have a remote control application installed therein to control the electronic device 100 or to perform a function, such as a voice recognition or the like. If the remote control application is installed in the external device, the external device may receive the user voices, and transmit and receive data to and from the electronic device 100 and control the electronic device using Wi-Fi/Bluetooth or infrared. Thus, the electronic device 100 may be provided with a plurality of interfaces part 110, which can communicate according to different communication methods.

The electronic device 100 may include a speaker 160. The speaker 160 outputs sounds based on audio data processed by the processor. The speaker 160 may include a unit speaker provided to correspond to audio data of any one audio channel, or a plurality of unit speakers provided to correspond to audio data of a plurality of audio channels. As another example, the speaker 160 may be provided separately from the electronic device 100. In this case, the electronic device 100 may transmit the audio data to the speaker 160 through the interface part 110.

The electronic device 100 may include a sensor 170. The sensor 170 may detect or sense a state of the electronic device 100 or a state around the electronic device 100, and transmit information about the detected state to the processor 180. The sensor 170 may include at least one of a magnet sensor, an acceleration sensor, a temperature/humidity sensor, an infrared sensor, a gyroscope sensor, a position sensor (for example, a Global Positioning System (GPS) sensor), a barometric pressure sensor, a proximity sensor, a RGB sensor (or illuminance sensor), but embodiments are not limited thereto. Because a function of each of the sensors can be intuitively inferred from a name thereof by a skilled person, the detailed description will be omitted. The processor 180 may store in the storage a sensing value which is defined by a tap between the electronic device 100 and the external device 200. Later, if a user event is to be detected, the processor 180 may identify whether the user event occurs based on whether the detected sensing value corresponds to the stored sensing values.

The electronic device 100 includes the processor 180. The processor 180 includes at least one hardware processor, which is implemented as a central processing unit (CPU), a chipset, a buffer, a circuit and/or so on, mounted on a printed circuit board. The processor may be implemented as a system on chip (SOC) according to design methods. The processor 180 may include circuits to implement various modules corresponding to various processes, such as a demultiplexer, a decoder, a scaler, an audio digital signal processor (DSP), an amplifier and so on. Here, some or all of these modules may be implemented as the SOC. For example, circuits related to image processing, such as the demultiplexer, the decoder, the scaler and the like, may be implemented as an image processing SOC, and the audio DSP may be implemented as a chipset separate from the SOC.

When a voice signal corresponding to a user voice is acquired through the microphone 150, etc., the processor 180 may convert the acquired voice signal into voice data. Here, the voice data may be text data obtained through a speech-to-text (STT) processing process, which converts the voice signal into the text data. The processor 180 may identify a command represented by the voice data and perform an operation according to the identified command. Both the voice data processing process and the command-identifying and performing process may be performed in the electronic device 100. However, in this case, because a system load and a storage capacity required to the electronic device 100 becomes large relatively, at least some of the processes may be performed by at least one server, which is communicably connected to the electronic device 100 through the network.

The processor 180 according to an embodiment may call at least one command from among commands of a software stored in a storage medium, and execute the called at least one command. Thus, the electronic device 100 and the like, may perform at least one function according to the called at least one command. The at least one command may include at least one code generated by a compiler or at least one code executable by an interpreter. The storage medium readable by the machine may be provided in a form of a non-transitory storage medium. Here, the “non-transitory storage medium” is a tangible device and indicates only that it does not include signals (for example, electromagnetic waves), and this term do not distinguish between a case where data is semi-permanently stored in the storage medium and a case where data is temporarily stored therein.

The processor 180 may use at least one of a machine learning algorithm, a neural network algorithm, or a deep learning algorithm as a rule based or artificial intelligence (AI) algorithm to perform at least some among a data analysis, a processing, and a result information generation for identifying whether a user event corresponding to a content transmission command occurs based on a signal which is detected through a sensor set as a first recognition sensitivity, identifying whether the user event is expected to occur based on acquired surrounding situation information, if it is identified that the user event is expected to occur, adjusting the sensor to be set as a second recognition sensitivity which is larger than the first recognition sensitivity, identifying the user event based on a signal which is detected through the adjusted sensor and performing a content transmission operation with the external device through an interface part based on the identified user event.

As an example, the processor 180 may perform a function of a learning block and a function of a recognition block. The learning block may perform a function of generating a learned neural network and the recognition block may perform a function of recognizing (or, deducing, predicting, estimating and determining) data using the learned neural network. The learning block may generate or update the neural network. To generate the neural network, the learning block may obtain learning data. As an example, the learning block may obtain the learning data from the storage 140 or the outside. The learning data may be data using for learning the neural network, and teach the neural network using data that performed the operations described above as the learning data.

Prior to teaching the neural network using the learning data, the learning block may perform a preprocessing operation with respect to the obtained learning data, or select data to be used in learning among a plurality of learning data. As an example, to process in a form of data adapted to learning, the learning block may process the learning data in a predetermined format, filter the learning data, or add/remove noise into/from the learning data. The learning block may generate neural network set up to perform the operations described above using the preprocessed learning data.

The learned neural network may be configured as a plurality of neural networks (or layers). Nodes of the plurality of neural networks have weight values, and the plurality of neural network may be connected each other, so that an output value of one neural network is used as an input value of the other neural network. The neural networks may include, for example, models, such as convolutional neural network (CNN), deep neural network (DNN), recurrent neural network (RNN), restricted Boltzmann machine (RBM), deep belief network (DBN), bidirectional recurrent deep neural network (BRDNN) and deep Q-network.

To perform the operations described above, the recognition block may obtain target data. The target data may be obtained from the storage 140 or the outside. The target data may be data, which becomes a recognition target for the neural network. Prior to applying the target data to the learned neural network, the recognition block may perform a preprocessing operation with respect to the obtained target data, or select data to be used in recognizing target data among a plurality of data. As an example, to process in a form of data adapted to recognizing, the recognition block may process the target data in a predetermined format, filter the target data, or add/remove noise into/from the target data. The recognition block may apply the preprocessed target data to the neural network, thereby obtaining an output value outputted from the neural network. The recognition block may obtain a probability value or a reliability value along with the output value.

As an example, a control method of the electronic device 100 according to an embodiment may be provided in a computer program product. The computer program product may include the commands of the software, which are executed by the processor 180, as described above. The computer program product may be traded as goods between the seller and the buyer. The computer program product may be distributed in a form of a storage medium (for example, CD-ROM) readable by the machine, or distributed (for example, downloaded or uploaded) directly on-line through an application store (for example, Play Store™) or between two user device (for example, smart phones). In a case of the on-line distribution, at least some of the computer program product may be momentarily stored or transitory generated in a storage medium readable by the machine, such as a memory in a server of a manufacturer, a server of application store, or a relay server.

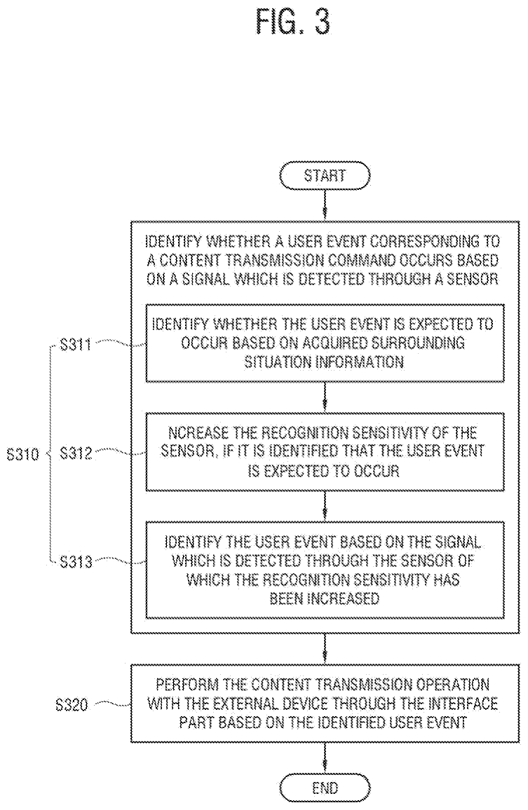

FIG. 3 is a flow chart illustrating an operation of the electronic device according to an embodiment of the disclosure.

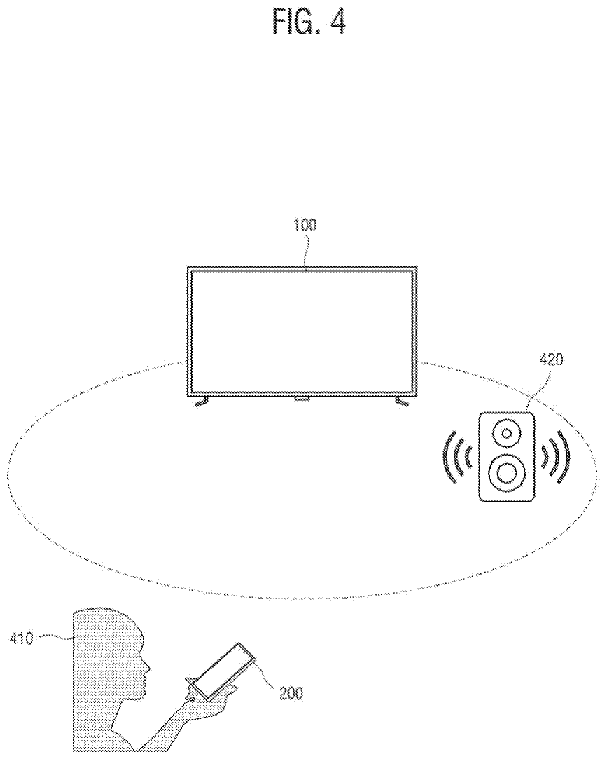

According to an embodiment of the disclosure, the processor 180 may identify whether a user event corresponding to a content transmission command occurs based on a signal which is detected through a sensor (S310). The sensor 170 in the disclosure may detect, for example, a vibration characteristic of the detected signal, where there are a wave form of the signal, a number of frequencies, a size of vibration, etc. as the vibration characteristic. The processor 180 may set a threshold value by considering a degree of the vibration characteristic of the detected signal. Also, the recognition sensitivity of the sensor 170 means a degree of sensitivity with which the sensor 170 responds to the signal detected from outside. Accordingly, that the recognition sensitivity is high means that the threshold value of the sensor 170 with respect to the vibration of the detected signal is low. For example, the sensor 170 may be set to have a first threshold value corresponding to a first recognition sensitivity. The sensor 170 which has been set as the first recognition sensitivity may detect a signal, for example, which has a size of vibration more than the first threshold value. Accordingly, if a user is far away where a signal having a vibration other than the user event occurs but the size of vibration is lower than the first threshold value, the user event is blocked and cannot be recognized validly. The operation S310 will be described in more detail with reference to FIG. 4, etc.

The processor 180 may perform a content transmission operation of a content with the external device 200 through the interface part 110 based on the identified user event (S320). The content includes all contents which are available such as a picture, video data, audio data, etc. Also, the content transmission operation includes transmitting to or receiving from the external device 200 and is not limited to anything.

With respect to the operation S310, in a process of identifying whether the user event corresponding to the content transmission command occurs, the processor 180 may identify whether the user event is expected to occur based on acquired surrounding situation information (S311). According to an embodiment of the disclosure, the surrounding situation information may be acquired, as illustrated in FIG. 1, from a situation which happens in a surrounding area 10 of the electronic device 100. For example, the processor 180 may receive the surrounding situation information from a user or the external device 200 through the interface part 110, and is not limited to anything. As an example of the surrounding situation information, the processor 180 may use an ultrasonic wave, radio frequency (RF) signal and infrared ray (IR) or a sound which is acquired through image sensing or the microphone 150, etc. to identify whether at least one of the user 410 surrounding the electronic device 100 or the external device 200 exists. For example, in the case of ultrasonic wave, the velocity of ultrasonic wave is about 340 meters per second in a normal air, where the processor 180 may radiate an ultrasonic wave pulse through the sensor 170 and detect a signal which hits and returns from the user 410 or the external device 200 to calculate a distance on the basis of a time difference thereon. At this time, if the calculated distance is identified to be within a predefined distance, the processor 180 may identify that the user 410 or the external device 200 exists near.

In the case of RF signal, the processor 180 may detect through the sensor 170 a signal which occurs from the external device 200 and estimate a distance between the external device 200 and the electronic device 100 with reference to the strength of the detect signal to identify whether the external device 200 exists. According to an embodiment of the disclosure, the disclosure may be applied to a case in which the user 410 holds the external device 200 in a hand, etc.

In the case of infrared ray, the processor 180 may detect an amount of the infrared ray which has been emitted through the sensor 170 and reflects and returns from the user 410 or the external device 200 to identify whether the user 410 or the external device 200 exists.

In the case of image sensing, the processor 180 may control a camera to obtain an image of surroundings of the electronic device 100 and analyze a size or shape, etc. of the user 410 or the external device 200 in the obtained image to identify whether the user 410 or the external device 200 exists within a predefined distance.

In the case of using a sound which is acquired from the microphone 150, as one of methods of estimating a direction in which the sound occurs, for example, a position of a sound source may be identified through a difference of times at which the sound reaches respective areas. When the sound occurs from the user 410 or the external device 200, there exists the difference of times at which the occurred sound reaches two points of the electronic device, respectively, where the processor 180 may use the velocity of the sound and the time which is taken for the sound to reach each point to know the distance from the user 410 or the external device 200 to the electronic device 100. At this time, if the calculated distance is identified to be within a predefined distance, the processor 180 may identify that the user 410 or the external device 200 exists near.

Also, the processor 180 may use a Bluetooth low energy (BLE) signal of a Bluetooth module to identify whether the user 410 or the external device 200 exists within a predefined distance. For example, when an advertising packet is received from the external device surrounding the electronic device, the distance between the electronic device and the external device may be identified through a received signal strength indicator (RSSI) value of the packet.

If it is identified that the user event is expected to occur, the processor 180 may increase the recognition sensitivity of the sensor 170 (S312). That is, when the user event is expected to occur, the processor 180 lowers the threshold value so that the sensor 170 may detect the user event better. Accordingly, the processor 180 may adjust the threshold value from the first threshold value which corresponds to the first recognition sensitivity to a second threshold value which corresponds to a second recognition sensitivity that is larger than the first recognition sensitivity. In this case, the sensor 170 which has been set as second recognition sensitivity may detect, for example, a signal which has the size of vibration more than the second threshold value that is lower than the first threshold value. In this way, because of adjusting the threshold value, although the user event having the size of vibration less than the first threshold value occurs, it is possible to recognize validly as the user event.

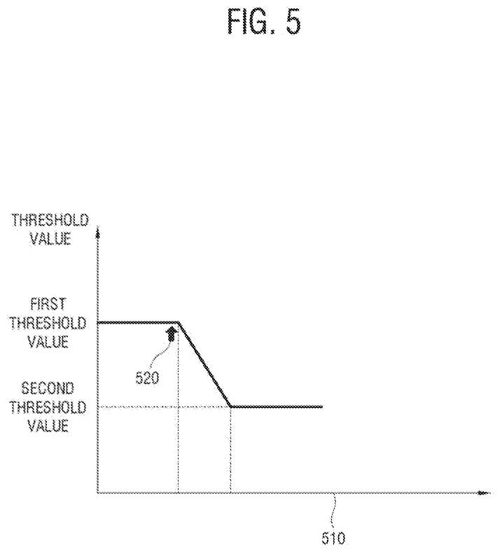

The processor 180 may identify the user event based on the signal which is detected through the sensor 170 of which the recognition sensitivity has been increased (S313). The operations S312 and S313 will be described in more detail with reference to FIG. 5, etc.

Hereinafter, as described above, when the user event is identified, the processor 180 may perform the content transmission operation with the external device 200 through the interface part 110 based on the identified user event (S320).

According to an embodiment of the disclosure, it is possible to raise the recognition rate of the user event and adaptively drive the sensor in accordance with the surrounding situation by adjusting the recognition sensitivity of the sensor based on the surrounding situation information of the electronic device.

FIG. 4 illustrates that the electronic device according to an embodiment of the disclosure operates. Hereinafter, the operation S310 of FIG. 3 mentioned above will be described in more detail with reference to FIG. 4. As illustrated in FIG. 4, in the embodiment of the disclosure, the user 410 or the external device 200 is supposed to be away from the electronic device 100 by more than a predefined distance. At this time, the predefined distance means a distance at which the user 410 or the external device 200 is so close to the electronic device 100 that the user event can be expected to occur. The predefined distance may be set by, for example, a manufacturer or be optimally set or changed by the processor 180 to be suitable for the user using information on a history of the user event, etc., is not limited to anything. The information on the history of the user event may be stored in the storage 140 or a server, where the processor 180 may receive the information from the storage 140 or the server and reset a setting value of the predefined distance at intervals. It is also possible to contribute to optimization of power efficiency by setting and changing the distance to identify within an appropriate distance whether the user event occurs.

As illustrated in FIG. 4, if the user 410 or the external device 200 is away from the electronic device 100 by more than the predefined distance, the user event may not be expected to occur. Also, there is supposed to exist an external speaker 420 in the predefined distance which surrounds the electronic device 100. The sensibility of the sensor 170 is set as a default of such situation in which the threshold value is high (refer to “first threshold value” of FIG. 5). Because the threshold value of the sensor 170 is high, the sensor 170 becomes less sensitive to a vibration of an internal speaker 160 which occurs in the electronic device 100, a vibration which occurs in the external speaker 420, etc. so as to reduce a situation in which the vibrations are misrecognized as the user event. Another embodiment, the processor 180 may set a basic threshold value with which the sensor 170 detects to be high only in a situation where the user event is expected to occur. In this case, the processor 180 may filter noise, etc. positively and effectively in accordance with the situation.

FIG. 5 illustrates a graph of a threshold value change of the sensor according to an embodiment of the disclosure. A graph 510 of FIG. 5 illustrates a threshold value which is adjusted when the user event is expected to occur as described in the operation S312 of FIG. 3. According to an embodiment of the disclosure, the sensor 170 of the electronic device 100 operates where the threshold value is set as the first threshold value. The processor 180 may acquire various types of the surrounding situation information as described above and identify whether the user event is expected to occur based on the acquired surrounding situation information. If the processor 180 identifies at a time 520 that the user event is expected to occur, the processor 180 may adjust the threshold value from the first threshold value to the second threshold value. However, the way in which the threshold value is adjusted is not limited to anything. The processor 180 may detect the user event based on a signal detected through the sensor 170 of which the threshold value has been adjusted to the second threshold value.

According to an embodiment of the disclosure, when the user event is expected to occur, it is possible to raise the recognition rate of the user event by adjusting the threshold value to be low.

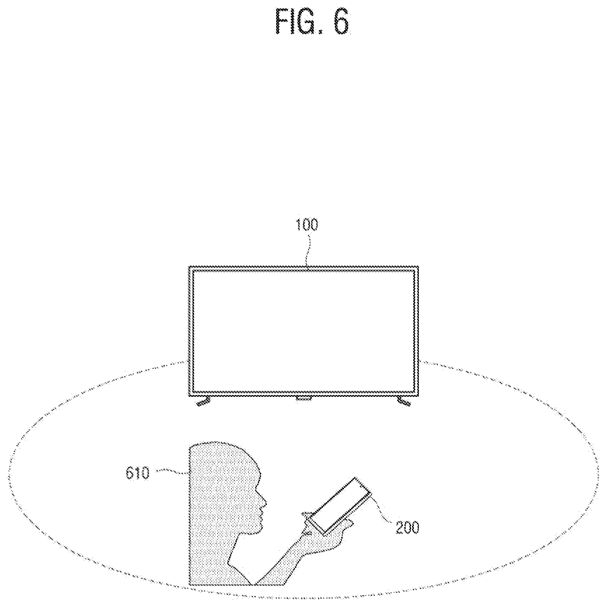

FIG. 6 illustrates that the electronic device according to an embodiment of the disclosure operates. In FIG. 6, the user 610 or the external device 200 is supposed to be within a predefined distance from the electronic device 100. Accordingly, the processor 180 may identify based on the surrounding situation information that at least one of the user 610 or the external device 200 exists in the surroundings of the electronic device 100. The principle of identification of FIG. 6 is the same as that described in FIG. 3.

According to an embodiment of the disclosure, the sensor 170 of the electronic device 100 operates where the threshold value is set as the first threshold value like FIG. 5. The processor 180 may acquire the surrounding situation information which indicates that at least one of the user 610 or the external device 200 exists within the predefined distance from the electronic device 100 and identify based on the acquired surrounding situation information that the user event is expected to occur.

In this case, the processor 180 may adjust the threshold value of the sensor 170 from the first threshold value to the second threshold value so as to easily recognize the user event when the user event occurs. The processor 180 may identify the user event based on a signal that is detected through the sensor 170 of which the threshold value has been adjusted to be the second threshold value.

Accordingly, the processor 180 may identify that at least one of the user or the external device exists within the predefined distance as the user event is expected to occur and is able to more easily recognize the user event by lowering the threshold value of the sensor 170.

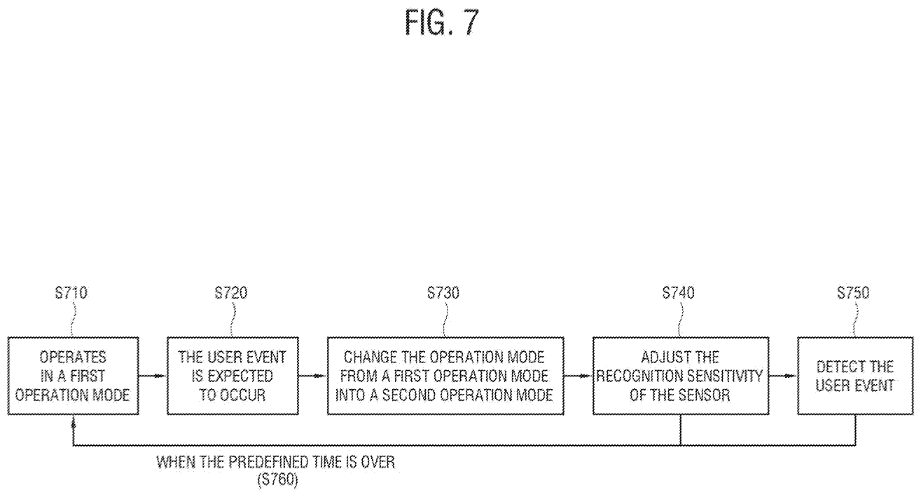

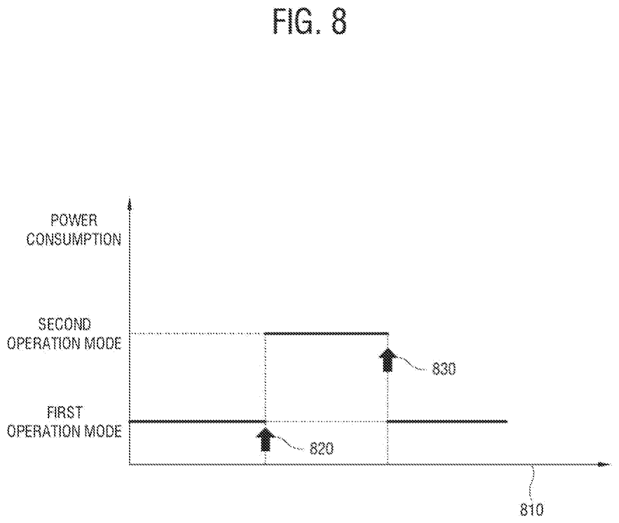

FIG. 7 is a flow chart illustrating that the electronic device according to an embodiment of the disclosure operates. FIG. 8 illustrates a graph of power consumption change of the sensor according to an embodiment of the disclosure. A graph 810 of FIG. 8 illustrates a power mode, which is described in FIG. 7, being changed.

Because the sensor 170 has to be in an operation state in order to identify the user event, that is, detect a vibration, the sensor 170 may have high power consumption. Accordingly, the power mode of the electronic device 100 may be divided into a first operation mode and a second operation mode which has higher power consumption than that of the first operation mode, where the processor 180 may change an operation mode of the sensor 170 according to the situation. For example, basically, the sensor 170 operates in a first operation mode which has low power consumption (S710). Accordingly, the first operation mode may be a power saving mode. While the sensor 170 is operating in the first operation mode, if the processor 180 identifies that the user event is expected to occur (S720), the processor 180 may change, at a time 820 that the user event is expected to occur, the operation mode from the first operation mode into a second operation mode in which the power consumption is larger (S730). Accordingly, the second operation mode may be an activated mode. When the sensor 170 operates in the activated mode, the processor 180 may adjust the recognition sensitivity of the sensor to easily recognize the user event (S740). On the other hand, if the processor 180 identifies that the user event is not expected to occur, because the operation mode can be continuously remained to be in the power saving mode, the operation mode may correspond to the basic threshold value which is set to be high so that the threshold value is not adjusted in FIG. 4. When the recognition sensitivity of the sensor is adjusted, the processor 180 may detect the user event (S750).

However, if the power mode is changed into the second operation mode and the user event is detect successfully or is changed into the second operation mode but the user event does not occur, that the second operation mode is continuously remained may cause power to be unnecessarily consumed. Accordingly, when the processor 180 identifies that the user event is not expected to occur until the predefined time has passed while the sensor 170 operates in the second operation mode, the processor 180 may control as the operation mode the sensor 170 to operate in the first operation mode again at a time 830 that the predefined time is over. At this time, the predefined time means a sufficient time with which the processor 180 can detect and identify the user event through the sensor 170.

Because the power mode is activated through such process, only when necessary, the power consumption can be efficiently reduced.

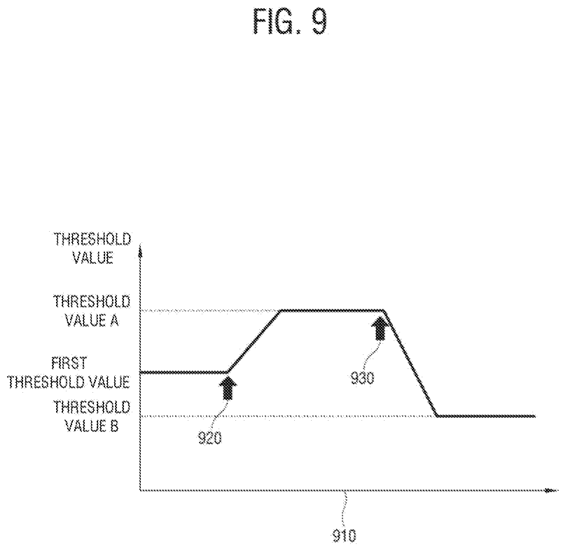

FIG. 9 illustrates a graph of threshold value change of the sensor according to an embodiment of the disclosure. FIG. 9 illustrates that when the processor 180 identifies that the user event is expected to occur, the processor 180 adjusts the recognition sensitivity for each of the user or external device allowing the user event to occur based on information on the user or external device.

The processor 180 may identify whether the user event which corresponds to at least one of a predefined user or external device is expected to occur. Information on the predefined user or external device means information which is stored in the storage 140 based on the user event that occurred previously or information which is receivable from a server, etc. through the interface part 110. That is, the information relates to a history that the user uses the external device to allow the user event to occur and may include a sensing value which is detected by the sensor 170 when the user event occurs for each user or external device. For example, it is supposed that there are histories in which users A and B used their external devices to allow the user event to occur, where the sensing values have to be at least threshold values A and B in order to be detected as the user event.

When the user event is expected to occur, the processor 180 may adjust the sensor 170 to be set as a third recognition sensitivity which corresponds to at least one of the predefined user or external device. According to an embodiment of the disclosure, while the sensor 170 detects the user event based on the first threshold value, at a time 920 that the processor 180 identifies that the user event by the user A is expected to occur, the processor 180 may adjust the threshold value to be the threshold value A based on the information on the user A. After the user A allows the user event to occur, at a time 930 that the processor 180 identifies that the user event by the user B is expected to occur, the processor 180 may adjust the threshold value to be the threshold value B based on the information on the user B. The embodiment according to FIG. 9 is merely an example and is not limited.

According to an embodiment of the disclosure, if information for each user or external device can be collected, it is possible to further raise the recognition rate of the user event by modifying the threshold value accordingly.

What is claimed is:

1. An electronic device comprising:
an interface;
a sensor; and
a processor configured to:
identify whether a user event which corresponds to a content transmission command occurs based on a signal that is detected through the sensor; and
perform a content transmission operation with an external device through the interface based on the identified user event,
wherein the processor is further configured to:
identify whether the user event is expected to occur based on acquired surrounding situation information;
when the user event is identified as being expected to occur, increase a recognition sensitivity of the sensor, and
identify the user event based on a signal that is detected through the sensor of which the recognition sensitivity has been increased.

2. The electronic device according to claim 1, wherein the sensor, while set to have a first recognition sensitivity, detects a signal that is more than a first threshold value, and the sensor, while set to have a second recognition sensitivity larger than the first recognition sensitivity, detects a signal that is more than a second threshold value lower than the first threshold value.

3. The electronic device according to claim 1, wherein the sensor detects a vibration characteristic of the signal and the processor identifies the user event based on the detected vibration characteristic.

4. The electronic device according to claim 1, wherein the processor identifies that the user event is expected to occur by identifying, based on the surrounding situation information, that at least one of a user or the external device exists in surroundings of the electronic device.

5. The electronic device according to claim 4, wherein the processor acquires the surrounding situation information which indicates that the at least one of the user or the external device exists within a predefined distance from the electronic device.

6. The electronic device according to claim 1, wherein the sensor operates in a first operation mode and, provided the processor identifies that the user event is expected to occur, the processor controls the sensor to operate in a second operation mode in which power consumption is larger than that of the first operation mode.

7. The electronic device according to claim 6, wherein provided the processor identifies that the user event is unexpected to occur until a predefined time has passed while the sensor operates in the second operation mode, the processor controls the sensor to operate in the first operation mode.

8. The electronic device according to claim 1, wherein the processor identifies whether the user event which corresponds to at least one of a predefined user or external device is expected to occur and, when the user event is expected to occur, adjusts the sensor to be to have a third recognition sensitivity which corresponds to the at least one of the predefined user or external device.

9. A method of controlling an electronic device, comprising:
identifying whether a user event which corresponds to a content transmission command occurs based on a signal that is detected through a sensor; and
performing a content transmission operation with an external device through an interface based on the identified user event,
wherein the identifying whether the user event occurs comprises:
identifying whether the user event is expected to occur based on acquired surrounding situation information;
when the user event is identified as being expected to occur, increasing a recognition sensitivity of the sensor; and
identifying the user event based on a signal that is detected through the sensor of which the recognition sensitivity has been increased.

10. The method according to claim 9, wherein the sensor, which is set as a first recognition sensitivity, detects a signal that is more than a first threshold value, whereas the sensor, which is set as a second recognition sensitivity larger than the first recognition sensitivity, detects a signal that is more than a second threshold value lower than the first threshold value.

11. The method according to claim 9, wherein the sensor detects a vibration characteristic of the signal and the identifying the user event comprises identifying the user event based on the detected vibration characteristic.

12. The method according to claim 9, wherein the identifying whether the user event is expected to occur comprises identifying that the user event is expected to occur by identifying based on the surrounding situation information that at least one of a user or the external device exists in surroundings of the electronic device.

13. The method according to claim 12, further comprising acquiring the surrounding situation information which indicates that the at least one of the user or the external device exists within a predefined distance from the electronic device.

14. The method according to claim 9, wherein the sensor operates in a first operation mode and the adjusting the sensor comprises, provided that the user event is identified as being expected to occur, controlling the sensor to operate in a second operation mode in which power consumption is larger than that of the first operation mode.

15. A non-transitory recording medium storing a computer program which includes a computer-readable code to perform a method of controlling an electronic device, the method comprising:
identifying whether a user event which corresponds to a content transmission command occurs based on a signal that is detected through a sensor; and
performing a content transmission operation with an external device through an interface based on the identified user event,
wherein the identifying whether the user event occurs comprises:
identifying whether the user event is expected to occur based on acquired surrounding situation information;
when the user event is identified as being expected to occur, increasing a recognition sensitivity of the sensor; and
identifying the user event based on a signal that is detected through the sensor of which the recognition sensitivity has been increased.
